(19) United States
(12) Patent Application Publication
(10) Pub. No.: US 2024/0273536 A1
(43) Pub. Date: Aug. 15, 2024

(54) SYSTEMS AND METHODS FOR ADVANCED USER AUTHENTICATION IN ACCESSING A COMPUTER NETWORK

(71) Applicant: MASTERCARD INTERNATIONAL INCORPORATED, Purchase, NY (US)

(72) Inventors: Chengxi Li, Riverside, CT (US); Christopher John Merz, Wildwood, MO (US); Felix Johannes Flory, Wildwood, MO (US)

(21) Appl. No.: 18/167,694

(22) Filed: Feb. 10, 2023

(51) Int. Cl. G06Q 20/40

(52) U.S. Cl. CPC G06Q 20/4016; G06Q 20/4014; G06Q 20/405

(57) ABSTRACT

An authentication platform for authenticating an online user is provided. The authentication platform includes a memory device including an authentication profile and at least one processor coupled to the memory device. The at least one processor is programmed to collect a plurality of authentication data from a plurality of transactions initiated by users attempting to perform a transaction over a computer network, analyze the plurality of authentication data to detect a plurality of insights representing relationships between data elements of different authentication requests of the plurality of authentication requests, wherein the insights represent a likelihood of fraud or potential approval with the corresponding authentication requests, determine a plurality of rules from the plurality of insights, filter the plurality of rules based on one or more thresholds, and provide the filtered plurality of rules to analyze a plurality of subsequent real-time transactions for detecting legitimate authentication requests.

### BACKGROUND

The present application relates generally to advanced user authentication over an electronic network, and more particularly, to authenticating online users on behalf of an access control server using data analytics-based authentication.

Computer systems are able to provide access to large amounts of data. In some cases, this data may be highly confidential data such that access to this data is restricted to those users requiring access and/or those users that are authorized to access such data. For example, healthcare data of a patient or financial data of a consumer may be highly confidential data that only the patient or consumer can access it and only those other persons that the patient or consumer approves to access such data. When access to such data is restricted, the computer system must employ authentication services to ensure that the persons accessing such data are legitimately authorized to access such data. In other words, if only the patient is authorized to access their data, then the computer system storing such data must be able to confirm that the patient is the person logging in to access their own data.

Another example of accessing restricted data includes the financial industry. Financial transactions conducted over electronic payment networks are growing exponentially. In some cases, these transactions are performed by parties over computer networks using payment cards and/or payment accounts wherein the payment cards or other forms of identification are not presented to the merchant at the time of the transaction. These card-not-present transactions (e.g., transactions in which the consumer does not actually provide a payment card to the merchant), oftentimes present a higher degree of fraud for the merchant. Accordingly, for such transactions, authentication procedures are often implemented to verify that the alleged cardholder is, in fact, the actual or legitimate cardholder.

Traditional transaction rule recommendations heavily rely on manual work and back-office review, which is inefficient and sometimes ineffective as transaction volume is tremendous and continues to grow. In addition, manual review relies on a subject-matter expert who has deep knowledge and experience in transaction and fraud risk assessment. Therefore, traditional manual review is not scalable in real-world application. Furthermore, one of the problems with conventional algorithms for mining associations between risk insights and the fraud target is that the number of association rules found is too large to handle, including many uninteresting suggestions (e.g., associations that appear but are not truly indicators of fraud or of data compromise or associations that rarely occur). These “interesting” rules can be missed or be difficult to quantify the targeted rule sets, which is particularly a problem when a transaction dataset has unbalanced class distributions in terms of fraud and genuine, as is typically the case in real-world applications.

Accordingly, it is desirable to have a computer-implemented authentication system that is capable of analyzing and recognizing fraud target insights of interest.

### BRIEF DESCRIPTION

In one aspect, an authentication platform for authenticating an online user is provided. The authentication platform includes a memory device including an authentication profile and at least one processor coupled to the memory device. The at least one processor is programmed to collect a plurality of authentication data from a plurality of transactions initiated by users attempting to perform a transaction over a computer network. At least some of the transactions were fraudulent or compromised. The plurality of authentication data includes a plurality of authentication requests each including a plurality of data elements. The at least one processor is also programmed to analyze the plurality of authentication data to detect a plurality of insights representing relationships between data elements of different authentication requests of the plurality of authentication requests. The insights represent a likelihood of fraud with the corresponding authentication requests. The at least one processor is further programmed to determine a plurality of rules from the plurality of insights. In addition, the at least one processor is programmed to filter the plurality of rules based on one or more thresholds. Furthermore, the at least one processor is programmed to provide the filtered plurality of rules to analyze a plurality of subsequent real-time transactions for detecting legitimate authentication requests.

In another aspect, a computer-implemented method for authenticating an online user is provided. The method is implemented on a computing device comprising a memory device coupled to at least one processor. The memory device includes an authentication profile. The method includes collecting a plurality of authentication data from a plurality of transactions initiated by users attempting to perform a transaction over a computer network. At least some of the transactions were fraudulent or compromised. The plurality of authentication data includes a plurality of authentication requests each including a plurality of data elements. The method also includes analyzing the plurality of authentication data to detect a plurality of insights representing relationships between data elements of different authentication requests of the plurality of authentication requests. The insights represent a likelihood of fraud with the corresponding authentication requests. The method further includes determining a plurality of rules from the plurality of insights. In addition, the method includes filtering the plurality of rules based on one or more thresholds. Furthermore, the method includes providing the filtered plurality of rules to analyze a plurality of subsequent real-time transactions for detecting legitimate authentication requests.

In a further aspect, at least one non-transitory computer-readable storage media having computer-executable instructions embodied thereon for authenticating an online user is provided. When executed by at least one processor, the computer-executable instructions cause the at least one processor to collect a plurality of authentication data from a plurality of transactions initiated by users attempting to perform a transaction over a computer network. At least some of the transactions were fraudulent or compromised. The plurality of authentication data includes a plurality of authentication requests each including a plurality of data elements. The computer-executable instructions also cause the at least one processor to analyze the plurality of authentication data to detect a plurality of insights representing relationships between data elements of different authentication requests of the plurality of authentication requests. The insights represent a likelihood of fraud with the corresponding authentication requests. The computer-executable instructions further cause the at least one processor to determine a plurality of rules from the plurality of insights. In addition, the computer-executable instructions cause the at least one processor to filter the plurality of rules based on one or more thresholds. Furthermore, the computer-executable instructions cause the at least one processor to provide the filtered plurality of rules to analyze a plurality of subsequent real-time transactions for detecting legitimate authentication requests.

### BRIEF DESCRIPTION OF THE DRAWINGS

FIGS. 1-6 show example embodiments of the methods and systems described herein.

FIG. 1 is a schematic diagram illustrating an example DAAA platform in communication with a multi-party payment processing system for processing transactions in accordance with one embodiment of the present disclosure.

FIG. 2 is an expanded block diagram of an example embodiment of a computer system used in analyzing the authentication of transactions.

FIG. 3 illustrates an example configuration of a server system such as the server system shown in FIG. 2.

FIG. 4 illustrates an example configuration of a client system shown in FIG. 2.

FIG. 5 is a schematic diagram illustrating transaction flow in using the DAAA system shown in FIG. 2.

FIG. 6 is a flow diagram of an example method for analyzing authentication information and authenticating a user using the DAAA system shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

The present application relates generally to advanced user authentication over an electronic network, and more particularly, to authenticating online users on behalf of an access control server using data analytics-based authentication. Data analytics-based authentication analyzes data associated with the user computer device accessing a computer network storing secure data. A data analytics-based authentication analysis (DAAA) server stores an authentication profile which includes rules for performing and routing authentication requests. The DAAA server receives a plurality of historical transaction messages and analyzes the plurality of historical transaction messages to determine correlations between the messages based on fraud processing. Then the DAAA server determines a plurality of rules based on the correlations. The DAAA server removes one or more of the plurality of rules based on one or more thresholds and/or one or more preferences. In some embodiments, the DAAA server provides the remaining rules to one or more issuer servers or other processing servers.

In other embodiments, the DAAA server applies the remaining rules to process transactions. In these embodiments, the DAAA server receives an authentication request message, and the authentication request message includes authentication data. The DAAA server extracts the authentication data from the authentication request message. The DAAA server then applies the remaining rules to the authentication data to determine whether or not to authenticate the authentication request message. The DAAA server then routes the result data to the appropriate location to make an authentication decision based on the result data.

In another example, a bank that issued a payment card for a transaction (referred to as the issuer) contracts with an access control server (ACS) for authentication services. In at least some embodiments, the ACS is associated with the DAAA server. In still further embodiments, the ACS is a part of the DAAA server. Specifically, the ACS analyzes at least some of the data associated with the transaction, determines whether or not it is likely that the alleged cardholder is, in fact, the actual or legitimate cardholder, and reports that determination to the issuer.

In a further embodiment, the DAAA server receives a plurality of previously processed authentication request messages for transactions. The plurality of previously processed authentication request messages also include whether or not the corresponding authentication request was fraudulent. In other embodiments, the DAAA server receives a plurality of information from a plurality of previously processed authentication request messages for transactions. In some of these embodiments, the plurality of information includes fraud processing calculations performed by one or more servers in the transaction authentication system.

Then the DAAA server uses artificial intelligence (AI) and/or machine learning (ML) to analyze the plurality of authentication information and/or the plurality of previously processed authentication request messages. In some embodiments, the DAAA server determines correlations between fraudulent authentication requests and differences between fraudulent and legitimate authentication requests. In one example, the DAAA server may analyze five million transactions and then detect 30 correlations, also call insights. For example, one of the insights could be that a high fraud score in a particular merchant class category is more indicative of a fraudulent authentication request. In another example, a transaction at a specific time of day for a specific geographic location is more indicative of a fraudulent authentication request. The authentication information can include, but is not limited to, cardholder shipping address, cardholder billing address, cardholder email address, cardholder phone number, merchant name, merchant category, merchant location, and/or at least one environment-related variable (e.g., device details, browser details) including device ID, IP address, device channel, etc. In some embodiments, the authentication information is hashed prior to storing to protect the security of this personally identifiable information.

Other authentication information can include, but is not limited to, a fraud probability score, a fraud analysis, at least one reason code, and step-up authentication results. The fraud probability score is a score representing a determined probability that the person associated with the transaction is the person associated the corresponding account, with lower scores indicating lower fraud risk and higher scores indicating higher fraud risk. In other words, the fraud probability score represents a likelihood that the suspect cardholder (e.g., the person attempting to perform a transaction) or the person attempting to access the account is the legitimate person (or cardholder) having the privileges to use the payment card to perform a payment transaction. For example, the fraud probability score may be represented by a number from 0-999 and/or by a fraud probability threshold category from 0-19. In some embodiments, fraud probability assessments that will be shared, such as through the authorization field of one or more messages, will be quantified on a scale of 0-9. Those of skill in the art will appreciate that any suitable fraud probability score may be used. In further embodiments, the transactions can also include a user attempting to access secure information on or over a computer network.

In some embodiments, the authentication information is associated with transactions from a single issuer bank. In other embodiments, the authentication information is associated with multiple issuer banks. In these embodiments, the authentication information may be otherwise limited, such as, but not limited to, by industry, merchant category, time of day, time of year, and/or any other limitation for which the user wishes to analyze transactions for insights.

The risk analysis is a description of a level of risk corresponding to the fraud probability score (e.g., low risk, medium risk, or high risk). Further the reason codes include one or more factors that influenced the fraud probability score. In some embodiments, the reason codes are generated using reason code categories and anchors, as described herein. For example, a fraud probability score of 900 or less may be considered low risk, a fraud probability score between 900 and 980 may be considered medium risk, and a fraud probability score above 980 may be considered high risk. Those skilled in the art will appreciate that any suitable fraud probability score thresholds and any number of risk levels may be used.

In at least one embodiment, the DAAA server analyzes the number of fraudulent transactions with the total number of transactions with similar attributes. In some of these embodiments, the DAAA server uses this analysis to determine if certain insights are important enough to use as rules. For example, an insight about time of day and merchant class category that is only 5% of the corresponding transactions is less important than an insight that occurs in 30% of the corresponding transactions. In some embodiments, the DAAA server limits the insights and rules to those that affect above a threshold amount of occurrences.

The following Table 1 lists a number of example data elements that may be used for authentication. For example, at least some of these data elements may be included in the authentication information included in an authentication request, while other data elements may be otherwise generated. Those of skill in the art will appreciate that the number of data elements could include more than those listed below, and for example could include over one hundred and seventy data elements. The authentication information may also be divided by category, such as: transaction data (amount, currency, date, and time), device data (IP address, device info, and channel data), cardholder data (account number and shipping address), and merchant data (name, category, and country).

TABLE 1

| | Data Element |
|---|---|
| 1 | Requestor Authentication Information |
| 2 | Requestor Challenge Indicator |
| 3 | Requestor ID |
| 4 | Requestor Initiated Indicator |
| 5 | Requestor Name |
| 6 | Requestor Non-Payment Authentication Indicator |
| 7 | Requestor Prior Transaction Authentication Information |
| 8 | Requestor URL |
| 9 | Server Operator ID |
| 10 | Server Reference Number |
| 11 | Server Transaction ID |
| 12 | Server URL |
| 13 | Account Type |
| 14 | Acquirer BIN |
| 15 | Acquirer Merchant ID |
| 16 | Challenge Mandated Indicator |
| 17 | Counter ACS to SDK |
| 18 | HTML |
| 19 | Operator ID |
| 20 | Reference Number |
| 21 | Rendering Type |
| 22 | Signed Content |
| 23 | Transaction ID |
| 24 | UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

In the example embodiment, transactions are categorized “fraudulent” or “genuine.” “Genuine” transactions are considered those that have been authenticated and fully processed. “Fraudulent” transactions are those that have been confirmed to be fraudulent, either during processing or afterwards. In some embodiments, “fraudulent” transactions were authenticated. In the example embodiment, one or more indicators in the authentication information indicate whether a transaction is “fraudulent” or “genuine.” One or more indicators may also indicate whether or not authentication was attempted on the transaction.

At least one of the technical problems addressed by this system includes: (i) inaccuracy of authentication services; (ii) inaccurate authentication in a real-time environment; (iii) inapplicability of rules applied for authentication processing; (iv) mis-classification of fraudulent transactions; and (v) an inability to move authentication services between different actors.

A technical effect of the systems and processes described herein is achieved by performing at least one of the following steps: i) collect a plurality of transaction data from a plurality of transactions, wherein the plurality of transactions are historical payment card transactions, wherein the plurality of transactions are associated with a single issuer processor, wherein the plurality of transactions are authentication requests, and wherein the plurality of transactions includes whether or not the authentication requests were fraudulent; ii) analyze the plurality of transaction data to detect a plurality of insights; iii) determine a plurality of rules from the plurality of insights, wherein the plurality of insights are based on one or more patterns between the plurality of transactions; iv) filter the plurality of rules based on one or more thresholds; v) provide the filtered plurality of rules to analyze a plurality of real-time transactions; vi) calculate a lift value for each of the plurality of rules; vii) filter the plurality of rules based on comparing each lift value to the one or more thresholds; viii) filter the plurality of rules based on one or more user preferences; ix) receive, in real-time, a current authentication request; x) analyze the current authentication request based on the filtered plurality of rules; xi) provide results of the analysis of the current authentication request; xii) receive a final outcome for the current authentication request; and xiii) update the filtered plurality of rules based on the final outcome and the results of the analysis of the current authentication request.

As will be appreciated, based on the description herein the technical improvement in the authentication system as described herein is a computer-based solution to a technical deficiency or problem that is itself rooted in computer technology (e.g., the problem itself derives from the use of computer technology). More specifically, fraud is significant problem for transactions conducted over an electronic payment network, especially for card-not-present transactions. Fraud (and unauthorized individuals attempting access) is also a significant problem of systems for securing information. Advanced fraud detection methodologies (e.g., DAAA) are useful to process transactions in a more efficient manner and without increasing network traffic and processing load. Accordingly, to address the problem with fraud and the aforementioned technical problems mentioned above, the systems and methods described herein address this technical problem by using a DAAA server and DAAA engine to perform analysis, determine rules, and filter results based on the rules to provide enhanced authentication information for making an authentication decision.

The following detailed description of the embodiments of the disclosure refers to the accompanying drawings. The same reference numbers in different drawings may identify the same or similar elements. Also, the following detailed description does not limit the claims.

Described herein are computer systems such as authentication computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to authenticating users for transactions conducted over an electronic payment network.

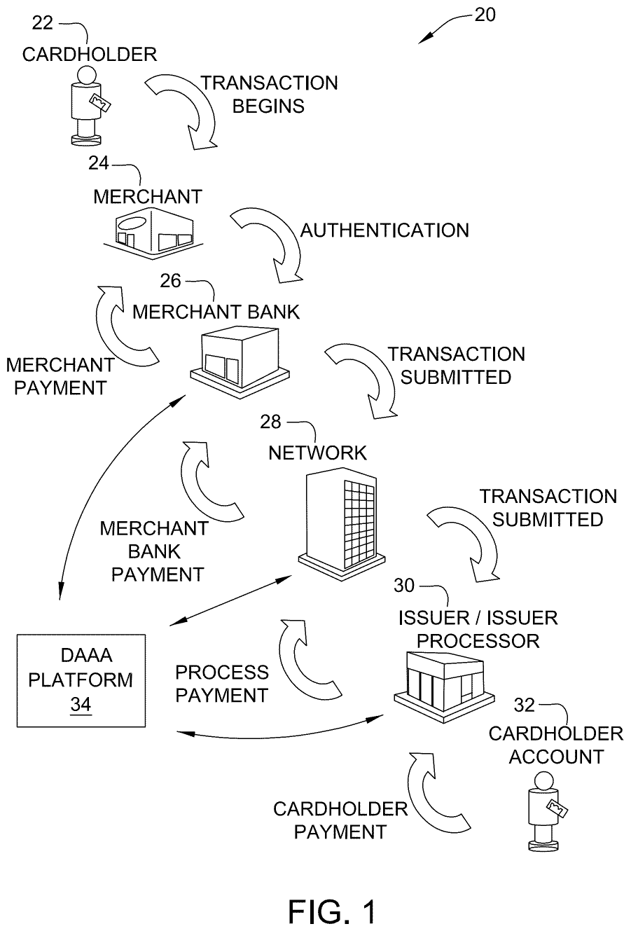

FIG. 1 is a schematic diagram illustrating an example DAAA platform 34 in communication with a multi-party payment processing system 20 for processing transactions in accordance with one embodiment of the present disclosure. FIG. 1 depicts a flow of data in a financial transaction through system 20. Embodiments described herein may relate to a transaction card system, such as a credit card payment system using the MASTERCARD® interchange network. The MASTERCARD® interchange network is a set of proprietary communications standards promulgated by Mastercard International Incorporated® for the exchange of financial transaction data and the settlement of funds between financial institutions that are members of Mastercard International Incorporated®. (MASTERCARD® is a registered trademark of Mastercard International Incorporated located in Purchase, New York).

In the exemplary transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authentication of the cardholder 22 and authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether the alleged cardholder is actually legitimate cardholder 22 (i.e., authentication), whether cardholder's 22 account 32 is in good standing, and whether the purchase is covered by cardholder's 22 available credit line. Based on these determinations, the requests for authentication and authorization will be declined or accepted. Authentication may be performed prior to authorization. If the requests are accepted, an authorization code is issued to merchant 24.

In the exemplary embodiment, the payment card system 20 includes or is in communication with a data analytics-based authentication analysis (DAAA) server 34. In this embodiment, the DAAA platform 34 provides enhanced meta-data collection to capture information, including meta-data from the transactions processed by the payment card system 20. The DAAA platform 34 stores this meta-data to use to provide as historical data when performing an authentication process prior to performing an authorization process. In the exemplary embodiment, the DAAA platform 34 may receive historical data from one or more of the acquirer bank 26, the interchange network 28, and the issuer 30. The historical data may include historical authorization and/or authentication data associated with a plurality of PANs, other historical data associated with the plurality of PANs, etc. The historical data may be associated with both card present and card not present historical transactions. For example, the historical data may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the historical data may be stored in a database accessible by DAAA platform 34 and operated by an interchange network 28. In some embodiments, the historical data will be hashed prior to storing to protect the security of this personally identifiable information.

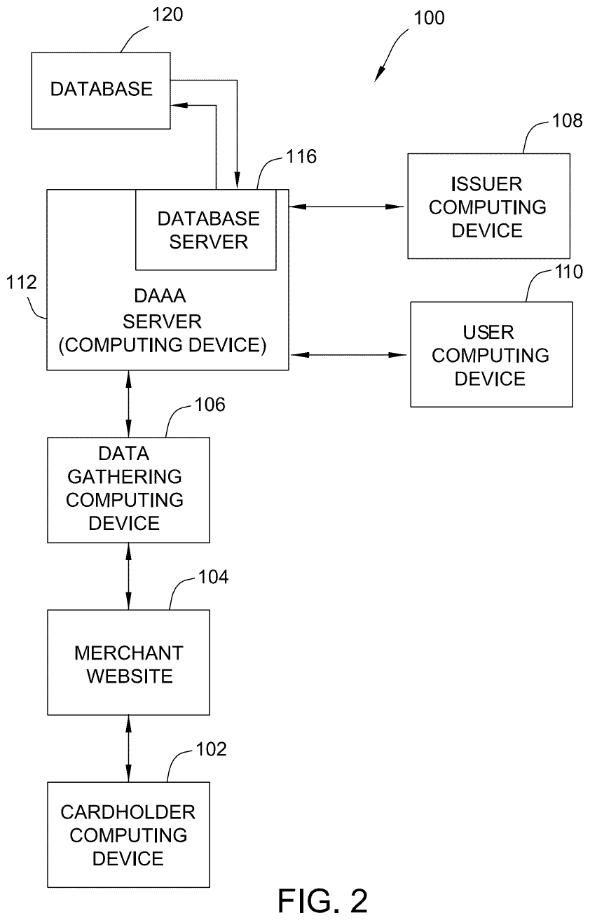

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction may be settled between issuer bank 30 and interchange network 28, and then between interchange network 28 and merchant bank 26, and then between merchant bank 26 and merchant 24.

As described below in more detail, data analytics-based authentication analysis (DAAA) may be performed by the DAAA server 34 on behalf of an access control server (ACS) or issuer bank 30 in the context of multi-party payment card system 20. Although the systems described herein are not intended to be limited to facilitate such applications, the systems are described as such for example purposes.

FIG. 2 is an expanded block diagram of an example embodiment of a computer system 100 used in analyzing the authentication of transactions. In the exemplary embodiment, system 100 may be used for determining rules for authenticating transactions. In other embodiments, the system 100 may be used for authenticating transactions using those rules. These transactions may include payment transactions as well as users attempting to access secure information over computer networks.

In the exemplary embodiment, cardholder computing devices 102 are computers that include a web browser or a software application, which enables cardholder computing devices 102 to access remote computer devices, such as merchant website 104, using the Internet or other network. More specifically, cardholder computing devices 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Cardholder computing devices 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, cardholder computing devices 102 are associated with individual cardholders 22 (shown in FIG. 1).

In the exemplary embodiment, merchant website 104 is an online shopping website that is reachable through computers that include a web browser or a software application, such as cardholder computing devices 102, using the Internet or other network. More specifically, merchant website 104 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Computing devices hosting merchant website 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, merchant website 104 are associated with merchant 24 (shown in FIG. 1). In the exemplary embodiment, merchant website 104 allows cardholder 22 to purchase goods and/or services using cardholder computing device 102. In some embodiments, transactions performed through merchant website 104 are considered card not present transactions. These transactions may include users attempting to access secure information over computer networks

In the exemplary embodiment, data gathering computer devices 106 are computers that include a web browser or a software application, which enables data gathering computer devices 106 to access remote computer devices, such as merchant website 104 and DAAA server 112, using the Internet or other network. More specifically, data gathering computing devices 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Data gathering computer devices 106 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, the data gathering computer devices 106 are associated with the DAAA server 112. In other embodiments, data gathering computer devices 106 are associated with acquirer bank 26 (shown in FIG. 1).

In the exemplary embodiments, data analytics-based authentication analysis (DAAA) server 112 is in communication with a plurality of data gathering computer devices 106 one or more issuer computer devices 108. In some embodiments, DAAA server 112 is similar to DAAA platform 34 (shown in FIG. 1). In the exemplary embodiment, DAAA server 112 receives data from the data gathering computer devices 106 and/or issuer computer devices 108 and uses that data to analyze transactions. In some embodiments, the DAAA server 112 receives data from the data gathering computer devices 106 and/or issuer computer devices 108 and uses that data to perform authentication of transactions, such as payment transactions and users attempting to access secure information. In some embodiments, DAAA server 112 performs the authentication process for the issuer 30 (shown in FIG. 1). In other embodiments, DAAA server 112 replaces the issuer bank 30 in the authentication process. In the exemplary embodiment, DAAA server 112 is associated with the interchange network 28 (shown in FIG. 1). In other embodiments, the DAAA server 112 is merely in communication with the interchange network 28.

In the exemplary embodiment, issuer computing devices 108 are computers that include a web browser or a software application, which enables issuer computing devices 108 to access remote computer devices, such as DAAA server 112, using the Internet or other network. More specifically, issuer computing devices 108 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Issuer computing devices 108 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, issuer computing devices 108 are associated with the issuer 30.

In the exemplary embodiment, user computing devices 110 are computers that include a web browser or a software application, which enables user computing devices 110 to access remote computer devices, such as DAAA server 112, using the Internet or other network. More specifically, user computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 116 is connected to database 120. In one embodiment, centralized database 120 is stored on server system 112 and can be accessed by potential users at one of user computing devices 110 by logging onto DAAA server 112 through one of client systems. In an alternative embodiment, database 120 is stored remotely from DAAA server 112 and may be non-centralized. Database 120 may be a database configured to store information used by DAAA server 112 including, for example, historical transaction records, including both payment transactions and users attempting to access secure information.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authentication and authorization request data. Database 120 may store one or more authentication profiles, where each authentication profile includes one or more authentication rules, one or more fraud probability level thresholds, and one or more routing rules based on the fraud probability level thresholds. In the exemplary embodiment, database 120 may store one or more determined rules. Furthermore, the database 120 may also store thresholds and/or preferences. These thresholds and/or preferences may be set by a user with a user computing device 110.

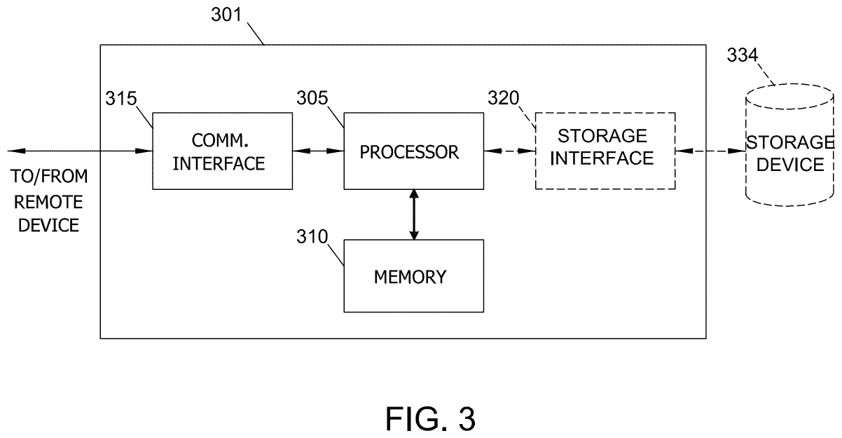

FIG. 3 illustrates an example configuration of a server system 301 such as DAAA platform 34 (shown in FIG. 1), in accordance with one example embodiment of the present disclosure. Server system 301 may also include, but is not limited to, merchant website 104, data gathering computer device 106, issuer computing device 108, DAAA server 112, and database server 116 (all shown in FIG. 2). In the example embodiment, server system 301 determines and analyzes characteristics of devices used in transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a user computing device 110 via the Internet, as illustrated in FIG. 2.

Processor 305 may also be operatively coupled to a storage device 334. Storage device 334 is any computer-operated hardware suitable for storing and/or retrieving data. In some embodiments, storage device 334 is integrated in server system 301. For example, server system 301 may include one or more hard disk drives as storage device 334. In other embodiments, storage device 334 is external to server system 301 and may be accessed by a plurality of server systems 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

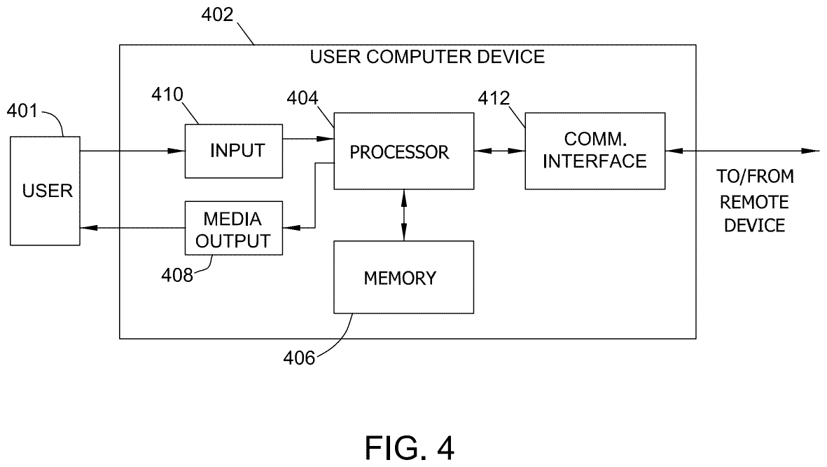

FIG. 4 illustrates an example configuration of a client computing device 402. Client computing device 402 may include, but is not limited to, cardholder computing device 102 (shown in FIG. 1), merchant website 104, data gathering computer device 106, and user computing device 110 (all shown in FIG. 2). Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

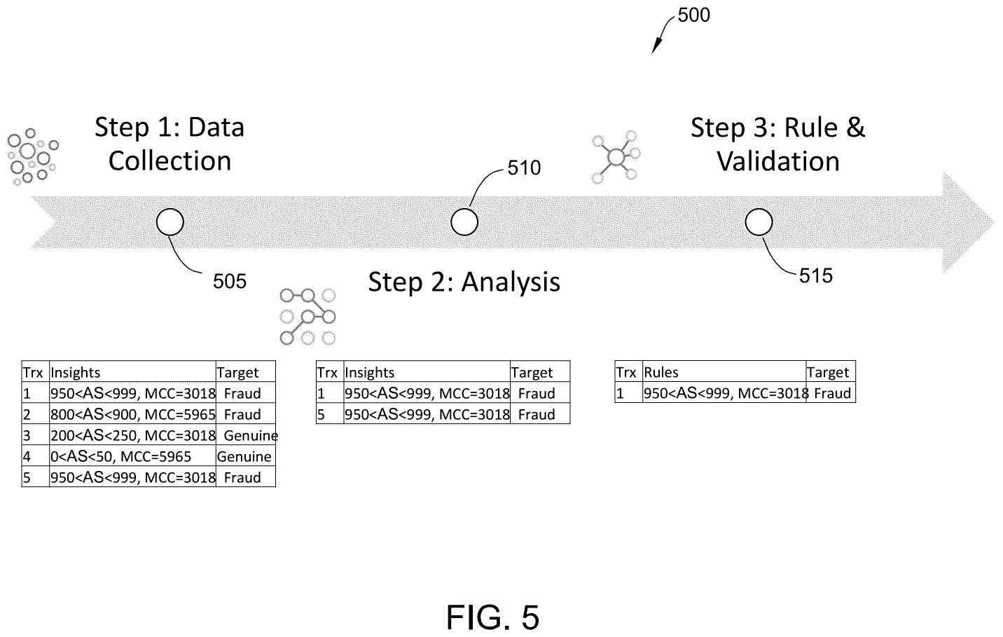

FIG. 5 is a schematic diagram illustrating transaction flow 500 in using the DAAA system 100 (shown in FIG. 2). In the exemplary embodiment, the steps of flow 500 are performed by the DAAA server 112 (shown in FIG. 2).

In the exemplary embodiment, the DAAA server 112 receives 505 a plurality of transactions. In at least some embodiment, the plurality of transactions are payment card transaction. In some other embodiments, the plurality of transactions can include, but are not limited to, debit card transactions, ATM (automated teller machine) transactions, card present transactions, card not present transactions, and/or any other type of transaction that the user and/or system 100 wishes to analyze. In the exemplary embodiment, these transactions have been previously completed and it has been determined whether or not these transactions are fraudulent or genuine. In some embodiments, the plurality of transactions are associated with a single issuer 30 (shown in FIG. 1). In other embodiments, the plurality of transactions are associated with a specific period of time (i.e., Black Friday, last weekend before Christmas, before school starts), a specific geographic area, a particular merchant 24 or merchant bank 26 (both shown in FIG. 1), and/or any other attributes that the user wishes to filter the transactions by.

In some embodiments, the transaction data is received 505 from the interchange network 28 (shown in FIG. 1). In other embodiments, the transaction is received 505 from the merchant, 24, merchant bank 26, and/or issuer 30 (all shown in FIG. 1). In some embodiments, the transaction data is received 505 in the authentication request format. In other embodiments, the transaction data is received 505 stored in records comprising a plurality of fields, such as those stored in database 120 (shown in FIG. 2).

In the exemplary embodiment, the DAAA server 112 analyzes 510 the plurality of transactions to search for associations. Association rule mining finds patterns and associations among the patterns. The associations can be used to recommend transaction rules for issuers 30 to leverage fraud probability assessments and to identify the high risk transactions. The recommended transaction rules can be used to simplify interpreting and understanding fraud probabilities for risk managers. However, general association rule discovery methods usually generate too many rules including a lot of uninteresting or not useful rules, especially when the fraud and genuine classes are imbalanced with the majority transactions are genuine.

Therefore, the DAAA server 112 also uses criteria to analyze the rules themselves to determine which rules should be used. The DAAA server 112 uses interestingness criteria which can be used in finding interesting rules in transaction data sets with very unbalanced fraud and genuine distributions.

In one embodiment, the DAAA server 112 can calculate interestingness or usefulness using a set of attributes is {A1, A2, . . . , An, C}. Each attribute can take a value from a discrete set of values. For example, Ai could be MCC (merchant category code), bucketed fraud probability score, reason code, etc. C is a special attribute that contains a set of categories called classes, i.e., fraud or genuine. Each transaction is Ti={A1, A2, . . . , An, C} and a set of transactions from a data set is denoted by D={T1, T2, . . . , Tn}. A pattern is a subset of transactions denoted as P. The support of a pattern P is the ratio of the number of records containing P to all records in D, denoted by sup(P). The confidence of the rule is defined as conf(P->C)=sup(P, C)/sup(P). The metric lift is defined by lift(P->c)=sup(P, C)/sup(P)sup(c). Lift refers to the likelihood of a transaction to be fraudulent. For the purposes of this discussion the lift calculates the number of times more likely a transaction is to be more fraudulent than a low risk/genuine transaction.

For the purposes of this discussion, a rule is interesting if its lift is far greater than 1. The lift values can be used to recommend a list of the rules to identify fraud, and also recommend the approval. For a large class, i.e., the genuine class, it can be difficult find any high lift rules from the large class using the lift metric. However, the proxy of low-risk category, for example: the risk score is low and the transaction is genuine, can be used as the target to suggest more approvals. The recommended rule will be delivered with certain thresholds on the lift as IF MCC=3018, fraud probability score>900, THEN fraud, Or in another example, if the fraud probability score=0, Reason Code=Trusted Environment, THEN approval.

For example, as shown in FIG. 5, a series of five transactions are received 505 by the DAAA server 112. The five transactions are analyzed 510 by the DAAA server 112. The five transactions include three attributes, AS (analysis score) which is a fraud processing score, MCC (merchant category code), and target, which is the results of the transaction. In the five transactions, three of them were fraudulent, while two were genuine. The DAAA server 112 analyzes 510 the transactions to find if there are any patterns. In this example, transactions one and five both have an AS between 950 and 999 and an MCC code of 3018. Accordingly, the DAAA server 112 can then set-up this as a rule. While there was another fraudulent transaction, transaction two, there was no correlation with other transactions to indicate a pattern or a rule. Furthermore, the lift for this rule can be calculated as 50, which means that that transactions identified by this rule are 50 times more likely to be fraudulent than the low risk/genuine transactions. This example is an oversimplification. In the exemplary embodiment, the plurality of transactions may include five million transactions. The DAAA server 112 may detect 30 rules, of which only 15 are selected to be used. These selected rules are then provided to the issuer 30 or whomever is performing authentication.

Once rules are discovered, then the DAAA server 112 analyzes and validates the rules. In these embodiments, the DAAA server 112 determines the lift for each of the detected rules and then determines whether or not each detected rule is important or interesting. In these embodiments, the DAAA server 112 determines if the lift for each rule exceeds a threshold. In some embodiments, the DAAA server 112 may also select rules based on other settings, preferences, or attributes, such as, but not limited to, the number of attributes associated with the rule or if a specific attribute is included in the rule.

Another example of analysis 510 and rule selection and validation 515 can be seen in TABLE 2, below.

TABLE 2

| | | | Fraud | | | Fraud | | |
|---|---|---|---|---|---|---|---|---|
| | | | BPS | Genuine | Fraud | BPS | Genuine | Fraud |
| RULES | Target | Lift | Count | Count | Count | Amount | Amount | Amount |
| 650 < Analysis | Fraud | 997 | 10,000 | 0 | 10 | 10,000 | 0 | 4703.7 |
| Score <= 700, | | | | | | | | |
| MCC = 3018 | | | | | | | | |
| 950 < Analysis | Fraud | 365 | 4871 | 179 | 170 | 3403 | 27833.1 | 14354.5 |
| Score <= 999, | | | | | | | | |
| MCC = 5965 | | | | | | | | |
| MCC = 3018 | Fraud | 864 | 884 | 17 | 130 | 9274 | 5298.1 | 67658.5 |

In the above table, BPS stands for basis point, which is calculated as a ratio of fraud volume over total volume times 10,000. In the first rule, there are no genuine transactions, but only 10 transactions overall. While the second rule was discovered over 349 transactions and last one was discovered over 147 transactions.

In this example, the analysis shows different rules and their corresponding lifts and likelihood. For example, while having an MCC of 3018 has a lift and thereby chance of fraud of 864, having an MCC of 3018 AND an AS between 650 and 700 has an even greater likelihood of fraud at a lift of 997.

A further example of analysis 510 and rule selection and validation 515 can be seen in TABLE 3, below.

TABLE 3

| | | | Fraud | | | Fraud | | |
|---|---|---|---|---|---|---|---|---|
| | | | BPS | Genuine | Fraud | BPS | Genuine | Fraud |
| RULES | Target | Lift | Count | Count | Count | Amount | Amount | Amount |
| Fraud Probability | Approve | 1.48 | 4.6 | 5.5M | 2531 | 10.33 | 35.9M | 37,137 |
| Score = 0, | | | | | | | | |
| Reason = TE | | | | | | | | |
| Fraud Probability | Approve | 1.93 | 1.34 | 1.6M | 220 | 1.55 | 7.1M | 1110 |
| Score = 1, | | | | | | | | |
| Reason = S | | | | | | | | |
| Reason = TE | Approve | 1.93 | 1.54 | 1.4M | 217 | 1.56 | 5.4M | 845 |

In this example, the analysis shows different rules and their corresponding lifts and likelihood. For example, while having fraud probability score of 0 and a reason code of a trusted environment has a lift of 1.48, just having a reason code of a trusted environment has a lift of 1.93. Furthermore, other reason codes may be determined to moderate the lifts of other fraud probability scores, such as where the reason code of (S) step-up challenge performed provides a lift of 1.93 for a fraud probability score of 1.

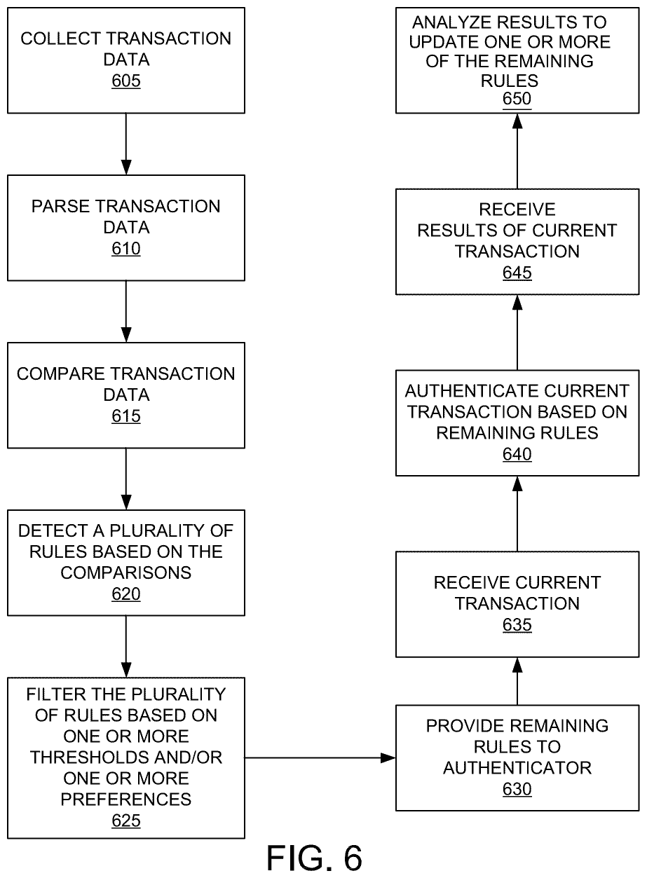

FIG. 6 is a flow diagram of an example method 600 for analyzing authentication information and authenticating a user using the DAAA system 100 (shown in FIG. 2). In the exemplary embodiment, the steps of method 600 are performed by the DAAA server 112 (shown in FIG. 2).

In the exemplary embodiment, the DAAA server 112 collects 605 transaction data. In at least some embodiment, the plurality of transactions are payment card transaction. In some other embodiments, the plurality of transactions can include, but are not limited to, debit card transactions, ATM (automated teller machine) transactions, card present transactions, card not present transactions, and/or any other type of transaction that the user and/or system 100 wishes to analyze. In the exemplary embodiment, these transactions have been previously completed and it has been determined whether or not these transactions are fraudulent or genuine. In some embodiments, the plurality of transactions are associated with a single issuer 30 (shown in FIG. 1). In other embodiments, the plurality of transactions are associated with a specific period of time (i.e., Black Friday, last weekend before Christmas, before school starts), a specific geographic area, a particular merchant 24 or merchant bank 26 (both shown in FIG. 1), and/or any other attributes that the user wishes to filter the transactions by.

The DAAA server 112 parses 610 the transaction data. In embodiments, where the transaction data is in authentication request messages or other formats, the DAAA server 112 parses 610 the transaction data into the appropriate fields. In some embodiments, the parsed transaction data is stored in a database, such as database 120 (shown in FIG. 2).

In the exemplary embodiment, the DAAA server 112 compares 615 the transaction data. The DAAA server 112 compares 615 the transaction data from different transactions to detect patterns. In a least one embodiment, the DAAA server 112 compares 615 the transaction data to find similarities between fraudulent transactions and differences between fraudulent and genuine transactions to detect those patterns.

In the exemplary embodiment, the DAAA server 112 uses the detected patterns to detect 620 a plurality of rules based on the comparisons. For example, the DAAA server 112 may detect a pattern that transactions are more likely to be fraudulent if they have MCC=3018. The DAAA server 112 then considers a rule to avoid transactions with MCC=3018. The DAAA server 112 filters 625 the rules based on one or more thresholds and/or one or more preferences. In the exemplary embodiment, the thresholds are lift thresholds. In this embodiment, the DAAA server 112 calculates the lift for each detected pattern and/or rule. The DAAA server 112 then filters 625 out those rules where the lift is below the threshold. In one further embodiment, the threshold for lift is 1. In other embodiments, the threshold for lift is higher. The DAAA server 112 may also filter 625 out rules based on one or more preferences set by one or more users. For example, the preference may indicate that rules cannot be primarily based on a single attribute or field of the transaction data. The settings and threshold may be stored in the database 120.

In the exemplary embodiment, the DAAA server 112 provides 630 the remaining rules to the authenticator. In some embodiments, the authenticator is associated with the issuer 30. In other embodiments, the authenticator could be associated with the interchange network 28, the merchant bank 26, and/or the merchant 24. Furthermore, the authenticator could be the DAAA server 112. The authenticator is under no obligation to use all of the rules, and in some embodiments, the authenticator has additional logic that it uses for determining whether or not to authenticate a transaction message.

In some embodiments, where the DAAA server 112 is the authenticator, the DAAA server 112 receives 635 a current transaction for authentication. The current transaction could be received as an authentication request. The authentication request could include additional information, such as, but not limited to, a fraud score, a reason code, and/or a fraud level. The additional information could have been calculated by a different computer device in the system 20 (shown in FIG. 1), such as, but not limited to, the merchant 24, merchant bank 26, interchange network 28, and/or issuer 30. The DAAA server 112 may receive 635 the current transaction from one of the merchant 24, merchant bank 26, interchange network 28, and/or issuer 30.

In these embodiments, the DAAA server 112 authenticates 640 the current transaction based on the remaining rules. The DAAA server 112 applies the data from the current transaction to the remaining rules and then determines the output. Based on the output, the DAAA server 112 determines whether or not to authenticate the current transaction. The DAAA server 112 then outputs its decision to one or more devices in the system 20.

At a subsequent time, the DAAA server 112 receives 645 the results of the current transaction. The results include whether the current transaction was fraudulent or genuine. The DAAA server 112 analyzes 650 the results and the current transaction to update one or more of the rules. In some embodiments, the DAAA server 112 does not update the rules because the authentication output matched the results. In other embodiments, the DAAA server 112 updates at least one rule because the authentication output did not match the results.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize association rules to identify the frequent patterns among transaction patterns and insights. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing transaction and authentication data, and detecting and analyzing fraud probabilities.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An authentication platform for authenticating an online user, the authentication platform comprising:
a memory device including an authentication profile; and
at least one processor coupled to the memory device, the at least one processor programmed to:
collect a plurality of authentication data from a plurality of transactions initiated by users attempting to perform a transaction over a computer network, wherein at least some of the transactions were fraudulent or compromised, and wherein the plurality of authentication data includes a plurality of authentication requests each including a plurality of data elements;
analyze the plurality of authentication data to detect a plurality of insights representing relationships between data elements of different authentication requests of the plurality of authentication requests, wherein the insights represent a likelihood of fraud with the corresponding authentication requests;
determine a plurality of rules from the plurality of insights;
filter the plurality of rules based on one or more thresholds; and
provide the filtered plurality of rules to analyze a plurality of subsequent real-time transactions for detecting legitimate authentication requests.

2. The authentication platform of claim 1, wherein the at least one processor is further programmed to:
calculate a lift value for each of the plurality of rules; and
filter the plurality of rules based on comparing each lift value to the one or more thresholds.

3. The authentication platform of claim 1, wherein the at least one processor is further programmed to filter the plurality of rules based on one or more user preferences.

4. The authentication platform of claim 1, wherein the plurality of transactions are historical payment card transactions.

5. The authentication platform of claim 4, wherein the plurality of transactions are associated with a single issuer processor.

6. The authentication platform of claim 1, wherein the plurality of transactions are authentication requests.

7. The authentication platform of claim 6, wherein the plurality of transactions includes whether or not the authentication requests were fraudulent.

8. The authentication platform of claim 1, wherein the plurality of transactions are to access secure information over a computer network.

9. The authentication platform of claim 1, wherein the plurality of insights are based on one or more patterns between the plurality of transactions.

10. The authentication platform of claim 1, wherein the at least one processor is further programmed to:
receive, in real-time, a current authentication request;
analyze the current authentication request based on the filtered plurality of rules; and
provide results of the analysis of the current authentication request.

11. The authentication platform of claim 10, wherein the at least one processor is further programmed to:
receive a final outcome for the current authentication request; and
update the filtered plurality of rules based on the final outcome and the results of the analysis of the current authentication request.

12. A computer-implemented method for authenticating an online user, the method implemented on a computing device comprising a memory device coupled to at least one processor, and the method comprises:
collecting a plurality of authentication data from a plurality of transactions initiated by users attempting to perform a transaction over a computer network, wherein at least some of the transactions were fraudulent or compromised, and wherein the plurality of authentication data includes a plurality of authentication requests each including a plurality of data elements;
analyzing the plurality of authentication data to detect a plurality of insights representing relationships between data elements of different authentication requests of the plurality of authentication requests, wherein the insights represent a likelihood of fraud with the corresponding authentication requests;
determining a plurality of rules from the plurality of insights;
filtering the plurality of rules based on one or more thresholds; and
providing the filtered plurality of rules to analyze a plurality of subsequent real-time transactions for detecting legitimate authentication requests.

13. The method of claim 12 further comprising:
calculating a lift value for each of the plurality of rules; and
filtering the plurality of rules based on comparing each lift value to the one or more thresholds.

14. The method of claim 12 further comprising filtering the plurality of rules based on one or more user preferences.

15. The method of claim 12, wherein the plurality of transactions are historical payment card transactions.

16. The method of claim 15, wherein the plurality of transactions are associated with a single issuer processor.

17. The method of claim 12, wherein the plurality of transactions are authentication requests and wherein the plurality of transactions includes whether or not the authentication requests were fraudulent.

18. The method of claim 12, wherein the plurality of insights are based on one or more patterns between the plurality of transactions.

19. The method of claim 12 further comprising:
receiving, in real-time, a current authentication request;
analyzing the current authentication request based on the filtered plurality of rules; and
providing results of the analysis of the current authentication request.

20. At least one non-transitory computer-readable storage media having computer-executable instructions embodied thereon for authenticating an online user, wherein when executed by at least one processor, the computer-executable instructions cause the at least one processor to:
collect a plurality of authentication data from a plurality of transactions initiated by users attempting to perform a transaction over a computer network, wherein at least some of the transactions were fraudulent or compromised, and wherein the plurality of authentication data includes a plurality of authentication requests each including a plurality of data elements;
analyze the plurality of authentication data to detect a plurality of insights representing relationships between data elements of different authentication requests of the plurality of authentication requests, wherein the insights represent a likelihood of fraud with the corresponding authentication requests;
determine a plurality of rules from the plurality of insights;
filter the plurality of rules based on one or more thresholds; and
provide the filtered plurality of rules to analyze a plurality of subsequent real-time transactions for detecting legitimate authentication requests.
